(19) United States
(12) Patent Application Publication
(10) Pub. No.: US 2013/0242800 A1
(43) Pub. Date: Sep. 19, 2013

(54) CLASSIFIER FOR RADIO FREQUENCY FRONT-END (RFFE) DEVICES

(71) Applicant: QUALCOMM INCORPORATED, San Diego, CA (US)

(72) Inventors: Hans Georg Gruber, San Diego, CA (US); Helena Deirdre O'Shea, San Diego, CA (US); Christian Holenstein, San Diego, CA (US)

(73) Assignee: QUALCOMM INCORPORATED, San Diego, CA (US)

(21) Appl. No.: 13/764,233

(22) Filed: Feb. 11, 2013

Related U.S. Application Data
(60) Provisional application No. 61/610,341, filed on Mar. 13, 2012.

(51) Int. Cl. H04B 1/40

(52) U.S. Cl. CPC H04B 1/40
USPC 370/254

(57) ABSTRACT

A method for classifying radio frequency front-end (RFFE) devices. The method includes enumerating a radio frequency front-end (RFFE) slave device according to at least one classifier bit within the RFFE slave device. The method also includes adjusting an RFFE control interface of an RFFE master device according to slave device configuration information determined from the at least one classifier bit within the RFFE slave device.

### CROSS-REFERENCE TO RELATED APPLICATION

The present application claims the benefit of U.S. Provisional Patent Application No. 61/610,341 filed on Mar. 13, 2012, in the names of H. G. Gruber et al., the disclosure of which is expressly incorporated by reference herein in its entirety.

### BACKGROUND

1. Field

Aspects of the present disclosure relate generally to wireless communication systems, and more particularly to a classifier for radio frequency front-end (RFFE) devices.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

As the demand for mobile broadband access continues to increase, the possibilities of interference and congested networks grows with more UEs accessing the long-range wireless communication networks and more short-range wireless systems being deployed in communities. Research and development continue to advance Universal Mobile Telecommunication System (UMTS) technologies not only to meet the growing demand for mobile broadband access, but to advance and enhance the user experience with mobile communications.

### SUMMARY

According to one aspect of the present disclosure, a method for classifying radio frequency front-end (RFFE) devices is described. The method includes enumerating a radio frequency front-end (RFFE) slave device according to at least one classifier bit within the RFFE slave device. The method also includes adjusting an RFFE control interface of an RFFE master device according to slave device configuration information determined from the at least one classifier bit within the RFFE slave device.

In another aspect, an apparatus for classifying RFFE devices is described. The apparatus includes at least one processor and a memory coupled to the at least one processor. The processor(s) is configured to enumerate a radio frequency front-end (RFFE) slave device according to at least one classifier bit within the RFFE slave device. The processor(s) is also configured to adjust an RFFE control interface of an RFFE master device according to slave device configuration information determined from the at least one classifier bit within the RFFE slave device.

In a further aspect, a computer program product for classifying RFFE devices is described. The computer program product includes a non-transitory computer-readable medium having program code recorded thereon. The computer program product has program code to enumerate a radio frequency front-end (RFFE) slave device according to at least one classifier bit within the RFFE slave device. The computer program product also has program code to adjust an RFFE control interface of an RFFE master device according to slave device configuration information determined from the at least one classifier bit within the RFFE slave device

In another aspect, an apparatus for classifying RFFE devices is described. The apparatus includes means for enumerating a radio frequency front-end (RFFE) slave device according to at least one classifier bit within the RFFE slave device. The apparatus further includes means for adjusting an RFFE control interface of an RFFE master device according to slave device configuration information determined from the at least one classifier bit within the RFFE slave device.

This has outlined, rather broadly, the features and technical advantages of the present disclosure in order that the detailed description that follows may be better understood. Additional features and advantages of the disclosure are described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of an access network.

FIG. 3 is a diagram illustrating an example of a radio protocol architecture for the user and control plane.

FIG. 4 is a diagram illustrating an example of an evolved Node B and user equipment in an access network.

FIG. 5 is a block diagram illustrating RF front-end (RFFE) interfaces for master and slave devices including a slave device configuration register to enable configuration of an RFFE control interface of the master device, according to one aspect of the present disclosure.

FIG. 6 is a block diagram further illustrating the RFFE interfaces of FIG. 5 including slave device classifier bits according to a further aspect of the present disclosure.

FIG. 7 is a block diagram illustrating a method for configuration of an RFFE control interface of a master device with slave device configuration information, according to one aspect of the present disclosure.

FIG. 8 is a block diagram illustrating an example of a hardware implementation in which an aspect of the disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

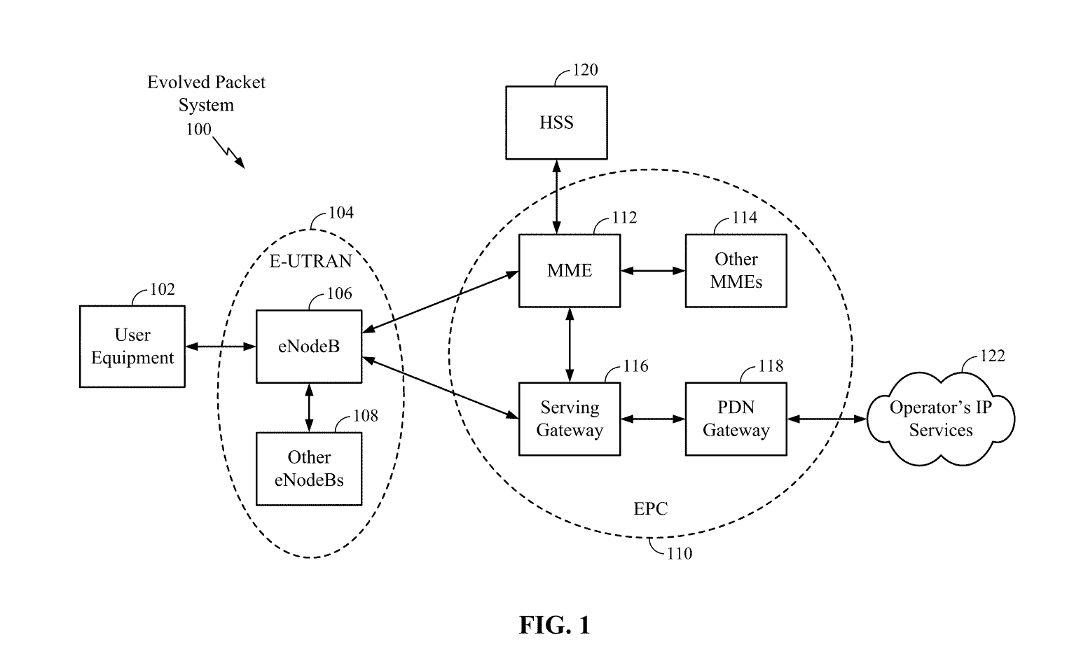

For clarity, certain aspects of the techniques are described below for LTE or advanced LTE (LTE-A) (together referred to in the alternative as “LTE/-A”) and use such LTE/-A terminology in much of the description below. FIG. 1 is a diagram illustrating an LTE/-A network architecture 100, in which a radio frequency front-end (RFFE) control interface may be implemented according to aspects of the present disclosure. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS 100 can interconnect with other access networks, but for simplicity, those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes the evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 with an RF front-end (RFFE) control interface configuration include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

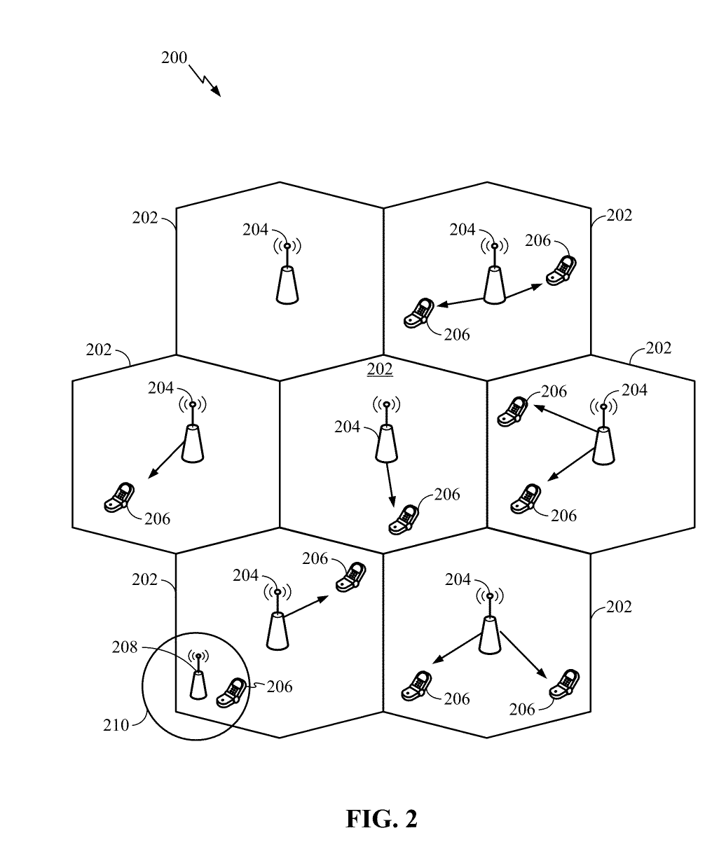

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. The lower power class eNodeB 208 may be a remote radio head (RRH), a femto cell (e.g., home eNodeB (HeNodeB)), pico cell, or micro cell. The macro eNodeBs 204 are each assigned to a respective one of the cells 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the downlink and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3^{rd} Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeBs 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

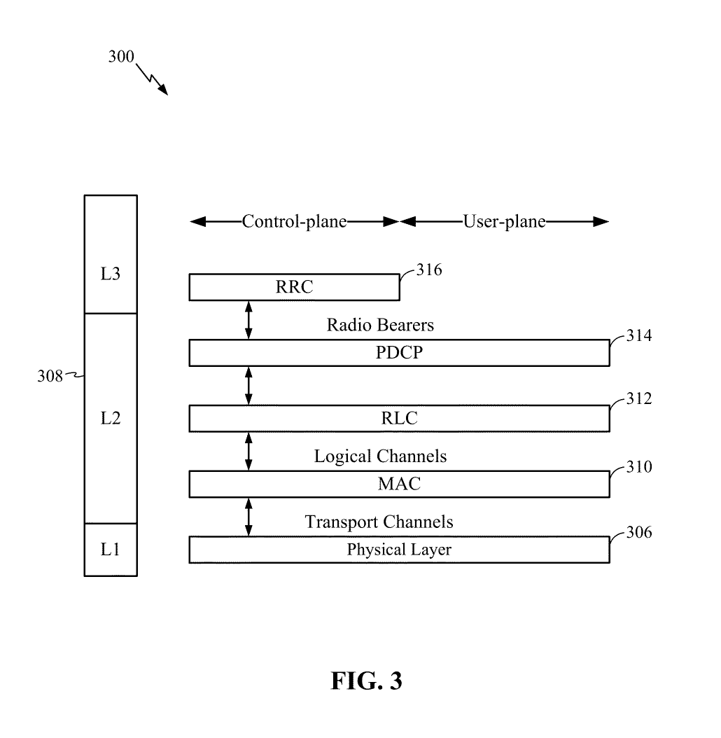

FIG. 3 is a diagram 300 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 306. Layer 2 (L2 layer) 308 is above the physical layer 306 and is responsible for the link between the UE and eNodeB over the physical layer 306.

In the user plane, the L2 layer 308 includes a media access control (MAC) sublayer 310, a radio link control (RLC) sublayer 312, and a packet data convergence protocol (PDCP) 314 sublayer, which are terminated at the eNodeB on the network side. Although not shown, the UE may have several upper layers above the L2 layer 308 including a network layer (e.g., IP layer) that is terminated at the PDN gateway 118 on the network side, and an application layer that is terminated at the other end of the connection (e.g., far end UE, server, etc.).

The PDCP sublayer 314 provides multiplexing between different radio bearers and logical channels. The PDCP sublayer 314 also provides header compression for upper layer data packets to reduce radio transmission overhead, security by ciphering the data packets, and handover support for UEs between eNodeBs. The RLC sublayer 312 provides segmentation and reassembly of upper layer data packets, retransmission of lost data packets, and reordering of data packets to compensate for out-of-order reception due to hybrid automatic repeat request (HARM). The MAC sublayer 310 provides multiplexing between logical and transport channels. The MAC sublayer 310 is also responsible for allocating the various radio resources (e.g., resource blocks) in one cell among the UEs. The MAC sublayer 310 is also responsible for HARQ operations.

In the control plane, the radio protocol architecture for the UE and eNodeB is substantially the same for the physical layer 306 and the L2 layer 308 with the exception that there is no header compression function for the control plane. The control plane also includes a radio resource control (RRC) sublayer 316 in Layer 3 (L3 layer). The RRC sublayer 316 is responsible for obtaining radio resources (i.e., radio bearers) and for configuring the lower layers using RRC signaling between the eNodeB and the UE.

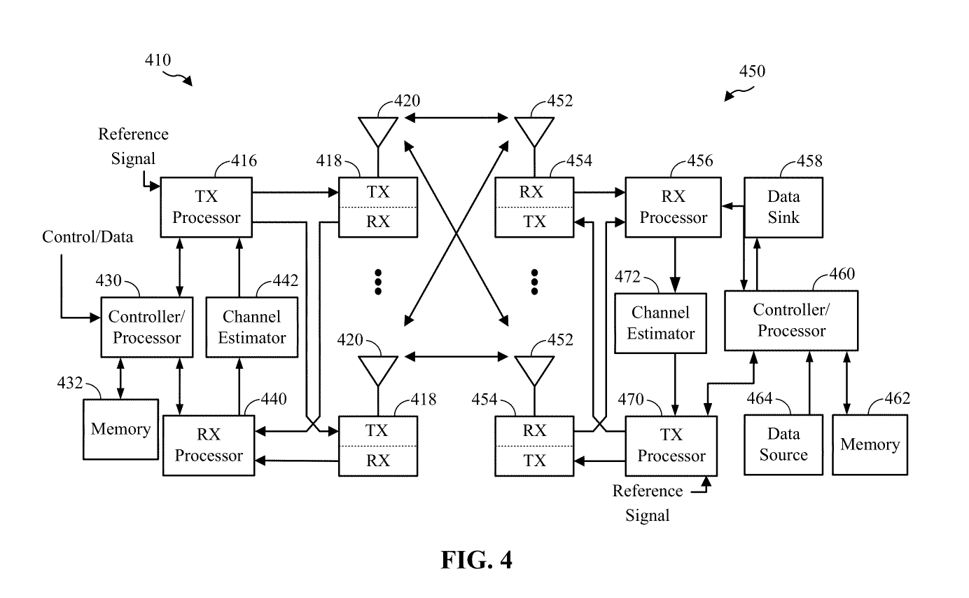

FIG. 4 is a block diagram of an eNodeB 410 in communication with a UE 450 having an RF front-end (RFFE) control interface configuration in an access network. In the downlink, upper layer packets from the core network are provided to a controller/processor of the eNodeB 410. The controller/processor 430 implements the functionality of the L2 layer. In the downlink, the controller/processor 430 provides header compression, ciphering, packet segmentation and reordering, multiplexing between logical and transport channels, and radio resource allocations to the UE 450 based on various priority metrics. The controller/processor 430 is also responsible for HARQ operations, retransmission of lost packets, and signaling to the UE 450.

The transmit (TX) processor 416 of the eNodeB 410 implements various signal processing functions for the L1 layer (i.e., physical layer). The signal processing functions includes coding and interleaving to facilitate forward error correction (FEC) at the UE 450 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 442 may be used to determine the coding and modulation scheme, as well as for spatial processing. The channel estimate may be derived from a reference signal and/or channel condition feedback transmitted by the UE 450. Each spatial stream is then provided to a different antenna 420 via a separate transmitter 418TX. Each transmitter 418TX modulates an RF carrier with a respective spatial stream for transmission.

At the UE 450, each of the receivers 454RX receives a signal through its respective antenna 452. Each of the receivers 454RX recovers information modulated onto an RF carrier and provides the information to the receive (RX) processor 456. The receive processor 456 implements various signal processing functions of the L1 layer. The receive processor 456 performs spatial processing on the information to recover any spatial streams destined for the UE 450. If multiple spatial streams are destined for the UE 450, they may be combined by the receive processor 456 into a single OFDM symbol stream. The receive processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNodeB 410. These soft decisions may be based on channel estimates computed by the channel estimator 472. The soft decisions are then decoded and deinterleaved to recover the data and control signals that were originally transmitted by the eNodeB 410 on the physical channel. The data and control signals are then provided to the controller/processor 460 of the UE 450.

The controller/processor 460 implements the L2 layer. The controller/processor 460 can be associated with a memory 462 that stores program codes and data. The memory 462 may be referred to as a computer-readable medium. In the uplink, the controller/processor 460 provides demultiplexing between transport and logical channels, packet reassembly, deciphering, header decompression, control signal processing to recover upper layer packets from the core network. The upper layer packets are then provided to a data sink 458, which represents all the protocol layers above the L2 layer. Various control signals may also be provided to the data sink 458 for L3 processing. The controller/processor 460 is also responsible for error detection using an acknowledgement (ACK) and/or negative acknowledgement (NACK) protocol to support HARQ operations.

In the uplink, a data source 464 is used to provide upper layer packets to the controller/processor 460. The data source 464 represents all protocol layers above the L2 layer. Similar to the functionality described in connection with the downlink transmission by the eNodeB 410, the controller/processor 460 implements the L2 layer for the user plane and the control plane by providing header compression, ciphering, packet segmentation and reordering, and multiplexing between logical and transport channels based on radio resource allocations by the eNodeB 410. The controller/processor 460 is also responsible for HARQ operations, retransmission of lost packets, and signaling to the eNodeB 410.

Channel estimates derived by a channel estimator 472 from a reference signal or feedback transmitted by the eNodeB 410 may be used by the transmit processor 470 to select the appropriate coding and modulation schemes, and to facilitate spatial processing. The spatial streams generated by the transmit processor 470 are provided to different antenna 452 via separate transmitters 454TX. Each of the transmitters 454TX modulates an RF carrier with a respective spatial stream for transmission.

The uplink transmission is processed at the eNodeB 410 in a manner similar to that described in connection with the receiver function at the UE 450. Each receiver 418RX receives a signal through its respective antenna 420. Each receiver 418RX recovers information modulated onto an RF carrier and provides the information to a receive processor 440. The receive processor 440 of the eNodeB may implement the L1 layer.

The controller/processor 430 implements the L2 layer. The controller/processor 430 can be associated with a memory 432 that stores program codes and data. The memory 432 may be referred to as a computer-readable medium. In the uplink, the controller/processor 430 provides demultiplexing between transport and logical channels, packet reassembly, deciphering, header decompression, control signal processing to recover upper layer packets from the UE 450. Upper layer packets from the controller/processor 430 may be provided to the core network. The controller/processor 430 is also responsible for error detection using an ACK and/or NACK protocol to support HARQ operations.

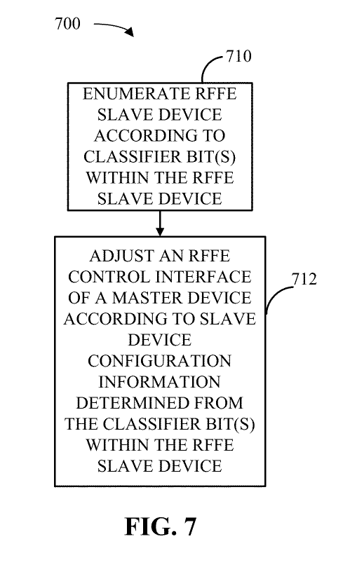

The controller/processor 430 and the controller/processor 460 may direct the operation at the eNodeB 410 and the UE 450, respectively. The controller/processor 430 and/or other processors and modules at the eNodeB 410 may perform or direct the execution of various processes for the techniques described herein. The controller/processor 460 and/or other processors and modules at the UE 450 may also perform or direct the execution of the functional blocks illustrated in use in the method flow chart of FIG. 7, and/or other processes for the techniques described herein. The memory 432 and the memory 462 may store data and program codes for the eNodeB 410 and the UE 450, respectively.

### Classifier for Radio Frequency Front-End (RFFE) Devices

A mobile industry solution, such as the Mobile Industry Processor Interface (MIPI) Alliance for a radio frequency (RF) front-end control interface (RFFE) specifies a control interface from an RF integrated circuit to the various RF front-end modules. As described herein, RF front-end modules may include, but are not limited to, power amplifiers, low noise amplifiers, power management modules, antenna tuners and sensors, and other like RF front-end modules. RFFE design specifies a reduced slave control complexity by providing a reduced gate-count for slave devices (e.g., approximately 300 to 500 gates). The reduced gate-count for RFFE slave devices generally limits the device configuration information available from an RFFE slave device.

In particular, the RFFE specification generally limits slave device information to a slave identification (Slave_ID), a product identification (Product_ID), and a manufacturer identification (Manufacturer_ID) of the slave device. Unfortunately, the slave identification, the product identification, and the manufacturer identification are insufficient for either a hardware or software configuration of an RFFE control interface of a master device.

In one aspect of the present disclosure, an RFFE slave device is modified to store slave device configuration information to enable configuration of an RFFE control interface of a master device. As described herein, the slave device configuration information may include, but is not limited to, a device class, technology changes and/or version changes for devices of the same class, device data, functional operation information/updates, and other like additional device data. For example, the slave device configuration information may include a slave device specification information (e.g., a revision identification), a minimum/maximum clock frequency, a minimum/maximum power level, slave device function(s), preferred RF communication frequency, electromagnetic interference level, device class, or other like configuration information. The slave device configuration information may enable adjustment of constant values for controlling an RF front-end (RFFE) control interface of a master device.

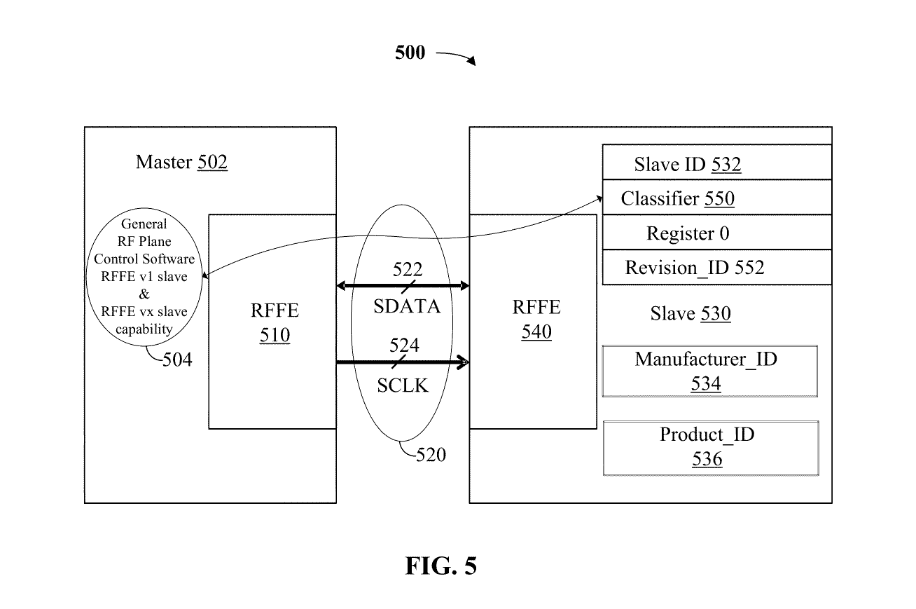

FIG. 5 is a block diagram illustrating a device 500 including RF front-end (RFFE) interfaces 510/540 for a master device 502 and a slave device 530, according to one aspect of the present disclosure. In this configuration, the slave device 530 includes a classifier register 550, the contents of which enable the configuration of the RFFE control interface 510 of the master device 502. Representatively, the master device 502 and the slave device 530 are communicably coupled through an RFFE bus 520 including data signals (SDATA) 522 and clock signals (SCLK) 524. In this configuration, an RF plane control software 504 may configure the RFFE control interface 510 according to the slave device configuration information determined from a classifier register 550 of the slave device 530. In one configuration, the slave device configuration information is determined from the classifier register 550 during an enumeration process following boot-up of the device 500. The device booting up includes both the master device 502 and the slave device 530, and could be the UE 450 of FIG. 4.

As shown in FIG. 5, the slave device 530 includes a slave ID 532, a manufacturer ID 534, and a product ID 536. Because the slave device 530 is a limited gate count device, the slave device configuration information is generally limited to the slave ID 532, the manufacturer ID 534, and the product ID 536. In this aspect of the disclosure, additional device information is provided within the classifier register 550, which may include a revision identification (Revision_ID) 552. For example, the RF plane control software 504 may determine a short description of version changes and/or technology changes for devices of the same device class as the slave device 530. This slave device configuration information may be determined from the classifier register 550. In one configuration, the RF plane control software 504 detects a slave device specification version, according to the Revision_ID 552, for configuring the RFFE control interface 510 of the master device 502.

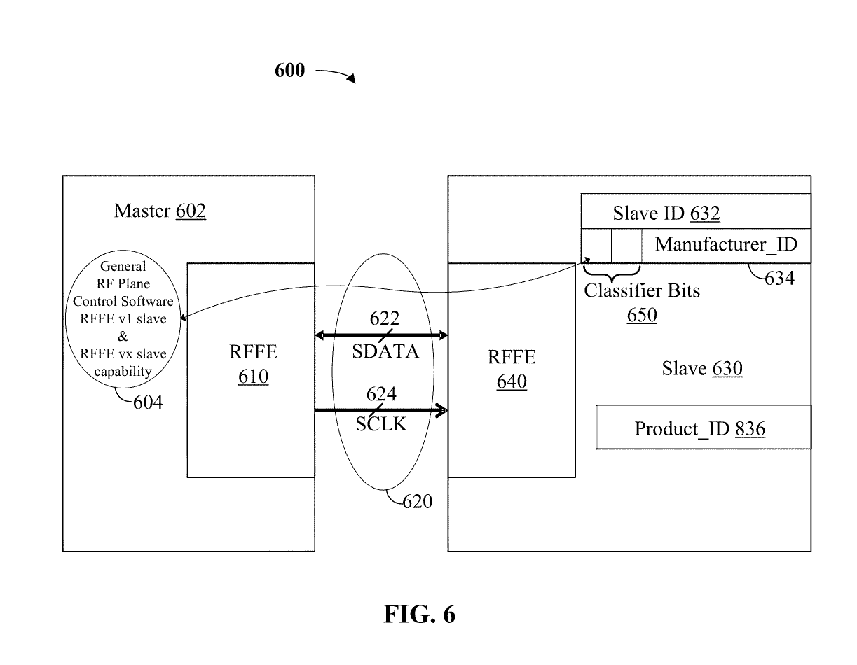

FIG. 6 is a block diagram 600 further illustrating the RFFE interfaces 510/540 of FIG. 5 including slave device classifier bits 650 according to a further aspect of the present disclosure. The master device 602 and the slave device 630 are also communicably coupled through an RFFE bus 620, including data signals (SDATA) 622 and clock signals (SCLK) 624. As shown in FIG. 6, the slave device configuration information of the slave device 630 is generally limited to the slave ID 632, the manufacturer ID 634, and the product ID 636. Additional device information may be provided within the slave device classifier bits 650 of the manufacturer ID 634. The additional information may be a revision identification. For example, the RF plane control software 604 may determine a minimum/maximum clock frequency, a minimum/maximum power level, slave device function(s), a preferred RF communication frequency, or an electromagnetic interference level of the slave device 630 for configuration of the RFFE control interface 610 of the master device 602.

FIG. 7 is a block diagram illustrating a method 700 for RF front-end (RFFE) control interface configuration, according to one aspect of the present disclosure. In block 710, a radio frequency front-end (RFFE) slave device is enumerated according to at least one classifier bit within the RFFE slave device. For example, the slave device 530 may be enumerated according to a slave ID 532 and the slave device configuration information determined from a classifier register 550, as shown in FIG. 5. As described herein, enumerating may refer to reading classifier bits from the classifier register 550 within the slave device 530.

Referring again to FIG. 7, in block 712, an RFFE control interface of an RFFE master device is adjusted according to slave device configuration information determined from the classifier bit(s) within the RFFE slave device. For example, the RFFE control interface 510 of the master device 502 is configured by the RF plane control software 504 according to any additional slave device information from the classifier register 550, as shown in FIG. 5. In an alternative configuration, the slave device configuration information is determined from the slave device classifier bits 650 within the manufacturer ID 634, as shown in FIG. 6.

Adjusting of the RFFE control interface 510 of the master device 502 may include an adjustment of a voltage level of the RFFE control interface 510 of the master device 502 according to the slave device configuration information. In addition, a clock frequency of the master device 502 may be adjusted according to the slave device configuration information. An RF communication frequency of the master device 502 may be adjusted according to a preferred RF communication frequency of the slave device 530, as indicated by the slave device configuration information. As noted, the slave device configuration information may include, but is not limited to, a slave device specification information, a minimum/maximum clock frequency, a minimum/maximum power level, slave devices function(s), preferred RF communication frequency, electromagnetic interference level, and/or device class.

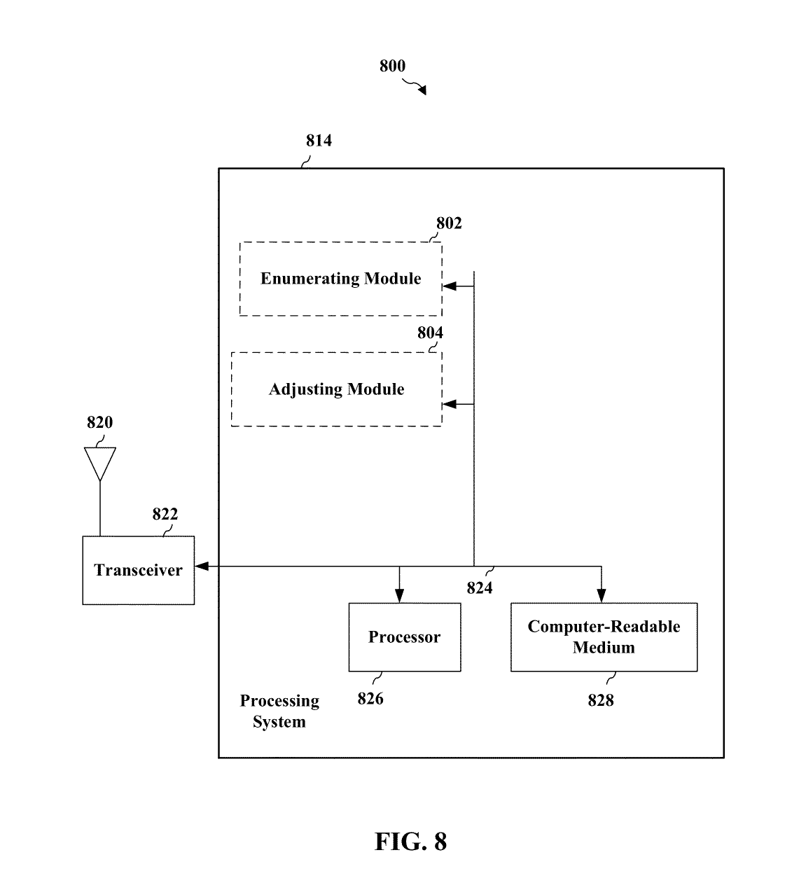

FIG. 8 is a diagram illustrating an example of a hardware implementation for an apparatus 800 employing an RFFE control interface configuration system 814. The RFFE control interface configuration system 814 may be implemented with a bus architecture, represented generally by a bus 824. The bus 824 may include any number of interconnecting buses and bridges depending on the specific application of the RFFE control interface configuration system 814 and the overall design constraints. The bus 824 links together various circuits including one or more processors and/or hardware modules, represented by a processor 826, an enumerating module 802, an adjusting module 804, and a computer-readable medium 828. The bus 824 may also link various other circuits such as timing sources, peripherals, voltage regulators, and power management circuits, which are well known in the art, and therefore, will not be described any further.

The apparatus includes the RFFE control interface configuration system 814 coupled to a transceiver 822. The transceiver 822 is coupled to one or more antennas 820. The transceiver 822 provides a way for communicating with various other apparatus over a transmission medium. The RFFE control interface configuration system 814 includes the processor 826 coupled to the computer-readable medium 828. The processor 826 is, e.g., responsible for general processing, including the execution of software stored on the computer-readable medium 828. The software, when executed by the processor 826, causes the RFFE control interface configuration system 814 to perform the various functions described for any particular apparatus. The computer-readable medium 828 may also be used for storing data that is manipulated by the processor 826 when executing software/firmware.

The RFFE control interface configuration system 814 further includes the enumerating module 802 for enumerating a radio frequency front-end (RFFE) slave device according to at least one classifier bit within the RFFE slave device. The RFFE control interface configuration system 814 also includes an adjusting module 804 for adjusting an RFFE control interface of an RFFE master device according to slave device configuration information determined from the classifier bit(s) within the RFFE slave device. The enumerating module 802 and the adjusting module 804 may be software/firmware modules running in the processor 826, resident/stored in the computer-readable medium 828, one or more hardware modules coupled to the processor 826, or some combination thereof. The RFFE control interface configuration system 814 may be a component of the UE 450 and may include the memory 462 and/or the controller/processor 460.

In one configuration, the apparatus 800 for wireless communication includes means for enumerating and means for adjusting. The means may be the enumerating module 802, the adjusting module 804 and/or the RFFE control interface configuration system 814 of the apparatus 800 configured to perform the functions recited by the enumerating means and the adjusting means. As described, the enumerating means may include the controller/processor 460, and/or the memory 462. The adjusting means may include the controller/processor 460, and/or memory 462. In another aspect, the aforementioned means may be any module or any apparatus configured to perform the functions recited by the aforementioned means.

The examples describe aspects implemented in an LTE/-A system. Nevertheless, the scope of the disclosure is not so limited. Various aspects may be adapted for use with other communication systems, such as those that employ any of a variety of communication protocols including, but not limited to, CDMA systems, TDMA systems, FDMA systems, and OFDMA systems.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
enumerating a radio frequency front-end (RFFE) slave device according to at least one classifier bit within the RFFE slave device; and
adjusting an RFFE control interface of an RFFE master device according to slave device configuration information determined from the at least one classifier bit within the RFFE slave device.

2. The method of claim 1, in which adjusting further comprises:
configuring radio frequency plane control software or hardware of the RFFE master device according to the slave device configuration information.

3. The method of claim 1, in which adjusting further comprises:
adjusting a voltage level of the RFFE control interface of the RFFE master device according to the slave device configuration information.

4. The method of claim 1, in which adjusting further comprises:
adjusting a clock frequency of the RFFE master device according to the slave device configuration information.

5. The method of claim 1, in which enumerating further comprises reading a plurality of classifier bits from a classifier register within the RFFE slave device.

6. The method of claim 1, in which the slave device configuration information comprises slave device specification information, a minimum/maximum clock frequency, a minimum/maximum power level, slave devices function(s), a preferred RF communication frequency, an electromagnetic interference level, and/or a device class.

7. An apparatus configured for wireless communication, the apparatus comprising:
a memory; and
at least one processor coupled to the memory, the at least one processor being configured:
to enumerate a radio frequency front-end (RFFE) slave device according to at least one classifier bit within the RFFE slave device; and
to adjust an RFFE control interface of an RFFE master device according to slave device configuration information determined from the at least one classifier bit within the RFFE slave device.

8. The apparatus of claim 7, in which the at least one processor is further configured to adjust by:
configuring a radio frequency plane control software or hardware of the RFFE master device according to the slave device configuration information.

9. The apparatus of claim 7, in which the at least one processor is further configured to adjust by:
adjusting a voltage level of the RFFE control interface of the RFFE master device according to the slave device configuration information.

10. The apparatus of claim 7, in which the at least one processor is further configured to adjust by:
adjusting a clock frequency of the RFFE master device according to the slave device configuration information.

11. The apparatus of claim 7, in which the at least one processor is further configured to enumerate by:
reading a plurality of classifier bits from a classifier register within the RFFE slave device.

12. The apparatus of claim 7, in which the slave device configuration information comprises a slave device specification information, a minimum/maximum clock frequency, a minimum/maximum power level, slave devices function(s), a preferred RF communication frequency, an electromagnetic interference level, or a device class.

13. A computer program product configured for wireless communication, the computer program product comprising:
a non-transitory computer-readable medium having program code recorded thereon, the program code comprising:
program code to enumerate a radio frequency front-end (RFFE) slave device according to at least one classifier bit within the RFFE slave device; and
program code to adjust an RFFE control interface of an RFFE master device according to slave device configuration information determined from the at least one classifier bit within the RFFE slave device.

14. An apparatus configured for operation within a wireless communication network, the apparatus comprising:
means for enumerating a radio frequency front-end (RFFE) slave device according to at least one classifier bit within the RFFE slave device; and
means for adjusting an RFFE control interface of an RFFE master device according to slave device configuration information determined from the at least one classifier bit within the RFFE slave device.

15. The apparatus of claim 14, in which the means for adjusting further comprises:
means for configuring a radio frequency plane control software or hardware of the RFFE master device according to the slave device configuration information.

16. The apparatus of claim 14, in which the means for adjusting further comprises:
means for adjusting a voltage level of the RFFE control interface of the RFFE master device according to the slave device configuration information.

17. The apparatus of claim 14, in which the means for adjusting further comprises:
means for adjusting a clock frequency of the RFFE master device according to the slave device configuration information.

18. The apparatus of claim 14, in which the means for enumerating further comprises means for reading a plurality of classifier bits from a classifier register within the RFFE slave device.

19. The apparatus of claim 14, in which the slave device configuration information comprises a slave device specification information, a minimum/maximum clock frequency, a minimum/maximum power level, slave devices function(s), a preferred RF communication frequency, an electromagnetic interference level, or a device class.
